(19) United States
(12) Patent Application Publication
(10) Pub. No.: US 2003/0154868 A1
(43) Pub. Date: Aug. 21, 2003

(54) Screen printing apparatus

(76) Inventors: Ian Patrick Mcevoy, Dorset (GB); John Bruce Knowles, Dorset (GB)

Correspondence Address: TransPotomac Plaza, Suite 306, 1033 N Fairfax Street, Alexandria, VA, 22314, US

(21) Appl. No.: 10/220,963

(22) PCT Filed: Mar. 8, 2001
(86) PCT No.: PCT/GB01/00999

(30) Foreign Application Priority Data
Mar. 8, 2000 (GB) 0005582.2

(51) Int. Cl. B41F 15/34

(52) U.S. Cl. 101/127.1

(57) ABSTRACT

A screen printing apparatus for printing a predeterminable pattern of deposits of printing material onto a workpiece, the screen printing apparatus comprising: at least one print module comprising, as a unitary assembly, a printing screen, a print head movably disposed above the printing screen and a drive mechanism for moving the print head with respect to the printing screen; and a positioning unit for positioning the print module with respect to the workpiece.

The present invention relates to a print module for a screen printing apparatus, and a screen printing apparatus for and method of screen printing predeterminable patterns of material deposits onto workpieces, in particular, though not exclusively, electronic components such as circuit boards and the like.

Such circuit boards typically comprise a printed circuit board (PCB) or substrate on which various electronic components are mounted and connected to conductive tracks by an electrically-conductive material provided thereon in a predetermined pattern. In a first manufacturing step, an electrically-conductive material is printed on the printed circuit board or substrate through a printing screen. In a further manufacturing step, electronic components are then mounted to the printed circuit board or substrate such that those components are connected to the conductive tracks to form an electric circuit.

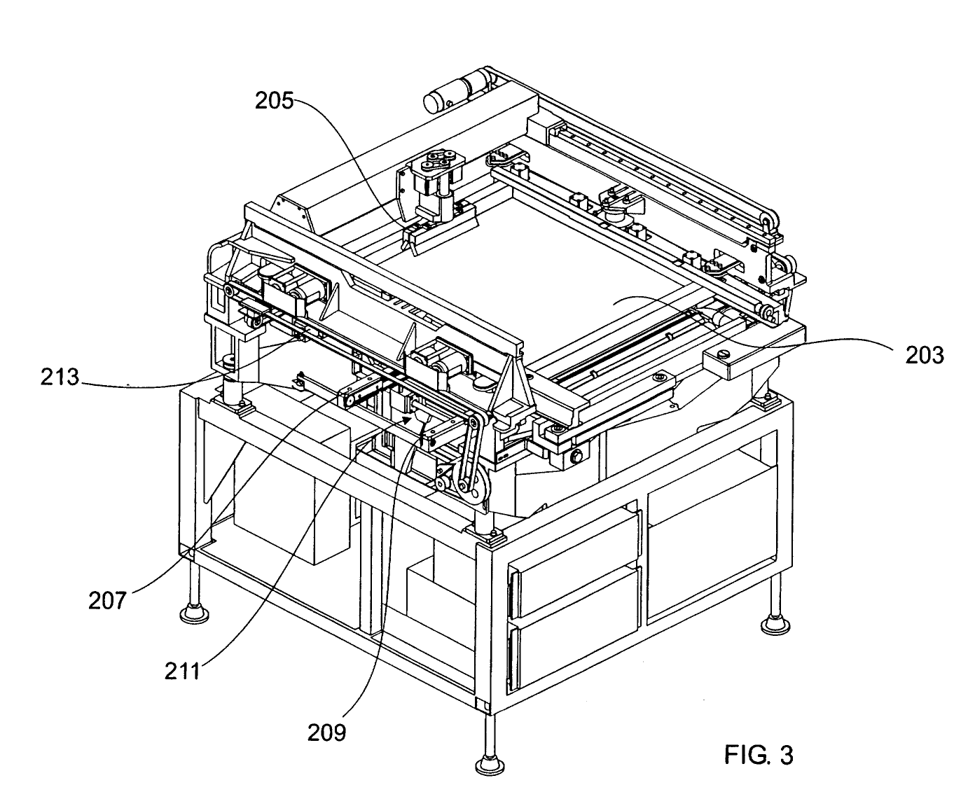

FIG. 3 illustrates a known screen printing apparatus. The apparatus comprises a substantially immobile printing screen 203 and a print head 205 which is movable back and forth across the printing screen 203 along a Y axis to drive printing material through a pattern in the printing screen 203 and onto a workpiece disposed therebelow. The apparatus further comprises a workpiece transport device which includes a pair of transport rails 207, 209 along which workpieces are transported to the printing zone, and a workpiece support mechanism 211 disposed beneath the printing screen 203.

The apparatus further comprises a video camera 213 which is movable along X and Y axes to position the camera 213 at known positions between the workpiece and the printing screen 203 to measure any misalignment of the workpiece and the printing screen 203. Once any misalignment of the workpiece and the printing screen 203 has been measured, positioning actuators are operated as required to correctly align the workpiece with the printing screen 203 before printing commences. In this apparatus, X axis, Y axis and θ axis positioning actuators are provided to translate or rotate the printing screen 203, as required, and correctly align the printing screen 203 with the workpiece disposed therebelow. Typically, any movement of the printing screen 203 is limited to less than 10 mm or 1.5 degrees, and is purely for aligning the printing screen 203 with a workpiece to be printed.

Whilst the abovementioned prior art screen printing apparatus is highly efficient in the high speed and high throughput production of PCBs, the apparatus lacks flexibility in being dedicated solely to screen printing and cannot easily be combined with other functions.

A further disadvantage is that the prior art screen printing apparatus is of fixed size, each one being limited to printing onto a particular range of workpiece sizes, typically to a range of workpieces that are smaller than the printing screen.

The prior art screen printing apparatus is also limited to printing onto planar workpieces, as the printing screen is only movable to a limited extent in X, Y and θ axes. As electronic devices become smaller, it is envisaged that printing of non-planar workpieces may be required; such printing of non-planar workpieces not being possible with the prior art apparatus.

It is therefore an aim of the present invention to address, and preferably alleviate, the impact of at least some of the above-described disadvantages associated with the prior art screen printing apparatus.

Accordingly, the present invention provides a print module for a screen printing apparatus, the print module comprising, as a detachable unitary assembly, a printing screen, a print head movable across the printing screen, and a drive mechanism for moving the print head with respect to the printing screen.

Preferably, the print module further comprises a housing to which the printing screen, the print head and the drive mechanism are mounted.

Preferably, the drive mechanism comprises a continuous belt connected to the print head and a motor for driving the belt to move the print head across the printing screen.

Preferably, the drive mechanism comprises at least one actuator which is operable to drive the print head into pressure contact with the printing screen.

Preferably, the print module further comprises a locator for locating the print module on the workpiece.

More preferably, the locator comprises a video camera which is movable with the print module to detect markers on the workpiece.

The present invention also provides a screen printing apparatus for printing a predeterminable pattern of deposits of printing material onto a workpiece, the screen printing apparatus comprising: at least one above-described print module; and a positioning unit for positioning a print module with respect to the workpiece.

Preferably, the print module is detachably mounted to the positioning unit.

More preferably, the apparatus comprises a plurality of print modules, with the printing screens of each being different.

Preferably, the positioning unit is configured to move, the print module in a plane along substantially orthogonal X and Y axes, and vertically towards and away from the workpiece along a Z axis substantially orthogonal to the X and Y axes.

More preferably, the positioning unit is configured to rotate the print module about a point in the plane defined by the X and Y axes.

Yet more preferably, the positioning unit is configured to rotate the print module about the Z axis.

Preferably, the positioning unit is configured to rotate the print module about the X axis.

Preferably, the positioning unit is configured to rotate the print module about the Y axis.

In one embodiment the positioning unit is a robotic positioning arm.

In another embodiment the positioning unit is a positioning assembly comprising an arm extending substantially parallel to the Y axis and to which the print module is mounted, a beam extending substantially parallel to the X axis, a pillar extending substantially parallel to the Z axis, and drive members for providing relative movement of the arm, the beam and the pillar.

Preferably, the positioning assembly further comprises a drive member for rotating the print module about the Z axis.

Preferably, the positioning assembly further comprises drive members for rotating the arm about the Y axis and the beam about the X axis.

Preferably, the positioning assembly further comprises a drive member for rotating the pillar about the Z axis.

Preferably, the printing screen has a smaller lateral dimension than that of the workpiece.

In a preferred embodiment the apparatus further comprises a workpiece transport device for transporting workpieces to the printing zone and a controller for controlling the operation of the apparatus.

The present invention also extends to a screen printing apparatus comprising a plurality of the above-described print modules, each having a different function, and movement means for selecting and moving the print modules. In a preferred embodiment the apparatus further comprises a controller for selecting and interchanging the print modules from the printing zone.

The present invention further provides a method of screen printing a predeterminable pattern of deposits of printing material onto a workpiece, the method comprising the steps of: picking up an above-described print module in an acquiring step; moving the selected print module to a predeterminable position above a workpiece in a printing zone; and moving the print module into abutment with the workpiece and operating the print module to print deposits of printing material onto the workpiece in a printing step.

Preferably, the method further comprises the steps of: moving the print module out of abutment with the workpiece, transporting a printed workpiece from the printing zone; and transporting another workpiece to the printing zone.

More preferably, the method further comprises the step of: moving the print module into abutment with the other workpiece and operating the print module to print deposits of printing material onto the other workpiece in a printing step.

Preferably, the method further comprises the steps of: moving the print module to a cleaning station; and cleaning the print head.

It is an advantage of the present invention that the printing screen can be easily cleaned by lifting the print module from the workpiece and wiping the same on a cleaning station to remove any excess printing material and other debris from the printing screen. Once clean, the print module can be returned for further printing operations.

The present invention vet further provides a method of printing a predeterminable pattern of deposits of printing material onto a workpiece, the method comprising the steps of: selecting a first print module; printing deposits of printing material onto a workpiece using the first-selected print module; returning the first-selected print module; selecting a second print module; and printing deposits of printing material onto the workpiece using the second-selected print module.

Preferably, the method further comprises the steps of: selecting a further print module; and printing deposits of printing material onto a workpiece using the further-selected print module.

In one embodiment the screen printing apparatus is provided as part of a kit which comprises a plurality of detachable and interchangeable units, such as, for example a screen printing unit and a component placement unit, means for selecting one or more of the units and respective moving means for moving the one or more selected units with respect to a workpiece.

Preferred embodiments of the present invention will now be described hereinbelow by way of example only with reference to the accompanying drawings, in which:

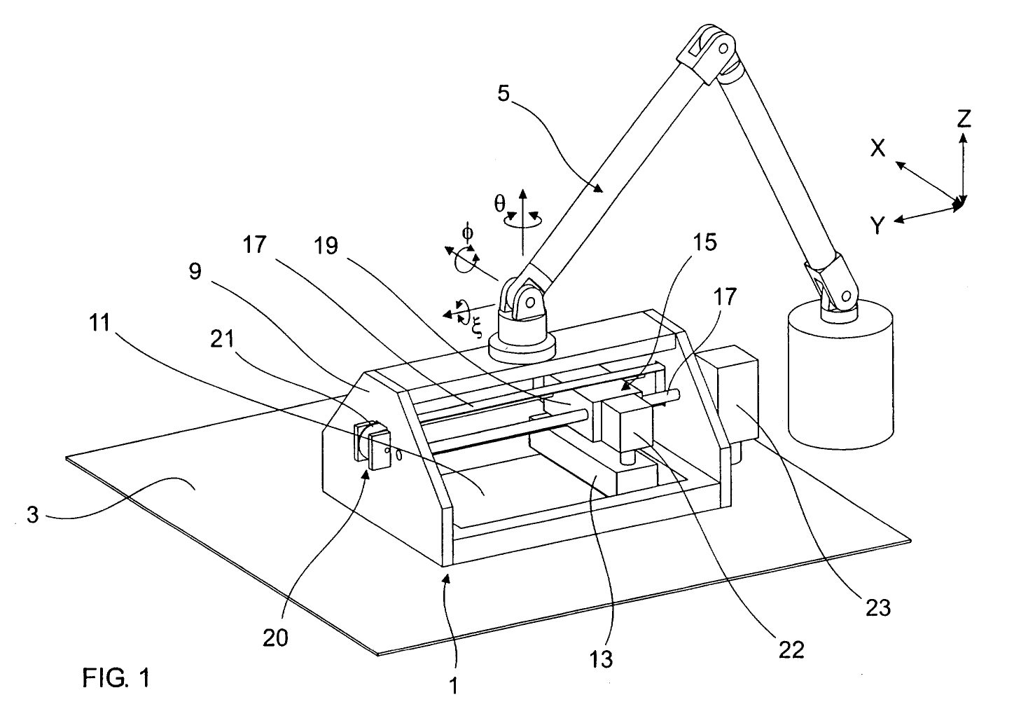

FIG. 1 illustrates a screen printing apparatus in accordance with a first embodiment of the present invention;

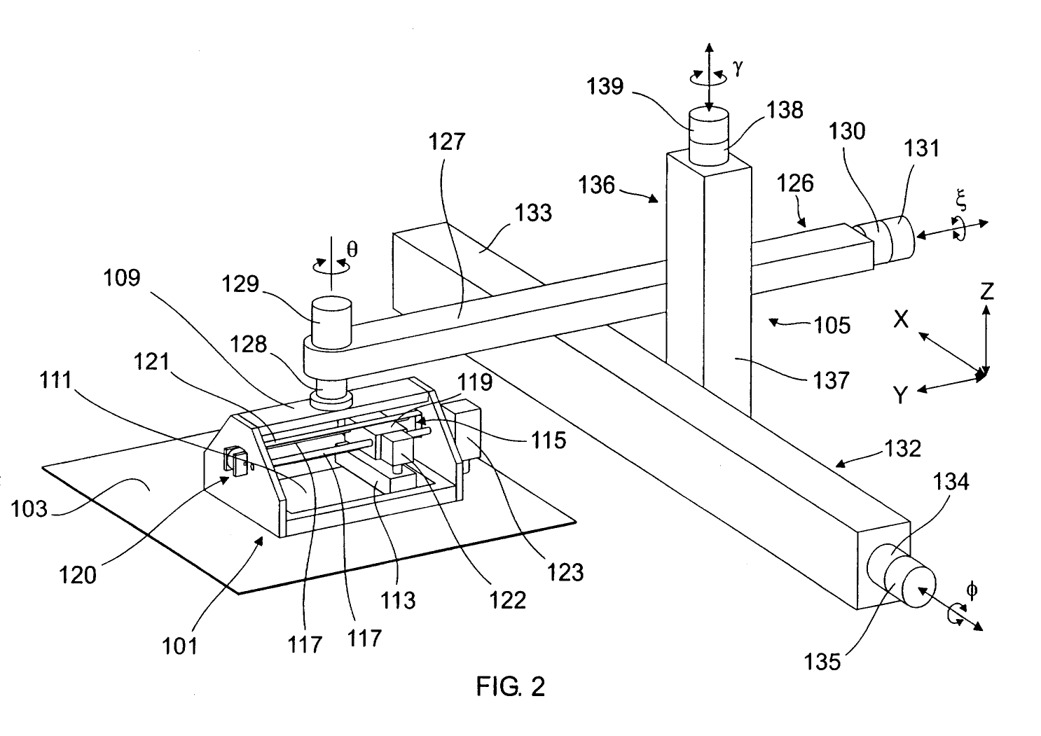

FIG. 2 illustrates a screen printing apparatus in accordance with a second embodiment of the present invention: and

FIG. 3 illustrates a prior art screen printing apparatus.

FIG. 1 illustrates a screen printing apparatus in accordance with a first embodiment of the present invention.

The apparatus comprises a print module 1 for printing a pattern of deposits of a printing material on a workpiece 3, in this embodiment a circuit board, an articulated, robotic positioning arm 5 for positioning the print module 1 on the workpiece 3, and a controller for controlling the print module 1 and the robotic arm 5.

The apparatus further comprises a workpiece transport device for transporting workpieces 3 to a printing zone in which the print module 1 is operable to print material deposits on a respective workpiece 3. In a preferred embodiment the workpiece transport device includes a pair of guide rails along which workpieces 3 are transported to the printing zone.

The print module 1 is a unitary assemble which comprises a housing 9, a printing screen 11 which is mounted to the housing 9, a print head 13 which is movably disposed relative to the housing 9 to apply printing material to the printing screen 11 and print material deposits on the workpiece 3, and a carriage assembly 15, for supporting and driving the print head 13 over the printing screen 11.

The print head 13 comprises a squeegee print head or a pressure-driven print head as disclosed, for example, in WO-A-98/16387. the content of which is hereby incorporated by reference. In a preferred embodiment the print head 13 is a pressure-driven print head; such a print head 13 advantageously allowing for the printing of inverted workpieces 3.

The carriage assembly 15 comprises a pair of guide rails 17, 17 which are mounted to the housing 9, a support block 19 which is slideably disposed to the guide rails 17, 17 and supports the print head 13, and a drive unit 20 which includes a motor-driven continuous drive belt 21 for driving the support block 19 and hence the print head 13 over the printing screen 11. In alternative embodiments the carriage assembly 15 could be driven by a worm drive, a pulley system or any other conventional drive mechanism.

The carriage assembly 15 further comprises at least one actuator 22 for biasing, the print head 13 into pressure contact with the printing screen 11 during printing.

The print module 1 further comprises an alignment system 23 for aligning the print module 1 to the workpiece 3 as required. In a preferred embodiment the alignment system 23 includes a video camera for locating fiducials or other locating indicators on 10 the workpiece 3. One suitable system is disclosed in WO-A-95/11475 and U.S. Pat. No. 5,752,446, the contents of which are hereby incorporated by reference.

In a preferred embodiment the print module 1 is detachable, preferably automatically from the robotic arm 5 such that different print modules 1, for example, with differently patterned and/or sized printing screens 11, can be interchanged as required. In one embodiment the print module 1 could be interchanged for each print run, potentially comprising a single workpiece 3, to allow for the printing of different patterns and/or differently-sized workpieces 3. In another embodiment the print module 1 could be interchanged to allow for the printing of a plurality of different patterns and/or pattern sizes on a single workpiece 3. It is a particular advantage that the print module 1 can be readily interchanged allowing for the use of print modules 1 having different screen patterns and/or screen sizes.

In this embodiment the print module 1 has a significantly smaller lateral dimension than the workpiece 3. In this way the print module 1 can, for example, be operated to print in a recess in the surface of the workpiece 3, which recess would not be accessible when using a printing screen 11 having the same lateral dimension as the workpiece 3 and also print a plurality of different patterns on the same workpiece 3. The present invention thus enables different combinations of circuit patterns to be printed easily and rapidly on a workpiece 3 without the need for dedicated printing screens 11 for each of the particular combinations of circuit patterns. Of course, in other embodiments the print module 1 could have a lateral dimension the same size or greater than the workpiece 3.

The robotic arm 5 is configured to provide for movement of the print module 1 in the X. Y and Z axes, which movement allows for the positioning of the print module 1 on the surface of the workpiece 3. In this embodiment the robotic arm 5 is configured to provide for angular rotation φ, ξ, θ of the print module 1 about each of the X, Y and Z axes. By providing for angular rotation θ about the Z axis, that is, an axis perpendicular to the plane of the printing screen 11, a pattern in the printing screen 11 can be deposited with an orient on a planar surface of the workpiece 3. By further providing for annular rotation φ, ξ about the X and Y axes, the print module 1 can be translated and rotated to any position in space and allows for printing onto non-planar surfaces.

In this embodiment the robotic arm 5 is attached to the print module 1 by a mechanical connection. In this embodiment the robotic arm 5 includes a clamp and the print module 1 includes a structural feature, for example, a protrusion or a handle, which is engaged by the clamp on the robotic arm 5. In another embodiment the print module 1 includes a clamp and the robotic arm 5 includes a structural feature, for example, a protrusion or a handle, which is engaged by the clamp on the print module 1.

In another embodiment the robotic arm 5 can be attached to the print module 1 by a magnetic connection. In one variant the robotic arm 5 could include an electromagnet which is magnetically clamped to the print module 1. In another variant the print module 1 could include an electromagnet which is magnetically clamped to the robotic arm 5.

In this embodiment the controller is a programmable computer. The controller can be programmed to position the print module 1 at the required position or sequentially at the required positions and control the operation of the print module 1.

In one mode of operation, the controller is programmed to operate the workpiece transport device to inwardly transport a workpiece 3 to the printing zone, and then operate the robotic arm 5 first to pick up a selected print module 1 from a store in an acquiring step, position the selected print module 1 in a predetermined position above the workpiece 3, and then, in a printing step, move the selected print module 1 into abutment with the workpiece 3 and drive the print head 13 across the printing screen 11 to deposit a pattern of deposits of printing material onto the workpiece 3. The printing step can then be repeated on further workpieces 3 until a given print run is completed. Where a plurality of workpieces 3 are to be printed in a print run, then at the same time, while a workpiece 3 is beings printed, a new workpiece 3 to be printed is transported to the printing zone and a printed workpiece 3 is transported from the printing zone. The print module 1 is then returned to the store by the robotic arm under the control of the controller. In a subsequent print run, a different print module 1, for example, with a differently-patterned printing, screen 1, could be picked up by the robotic arm 5, whereupon the above steps would then be repeated to provide a print run of workpieces 3 having the different printed pattern thereon. The printing steps may be interrupted with a cleaning step in which the print module 1 is moved to a cleaning station and the printing screen 11 wiped clean, as required.

In another mode of operation, where a customised pattern of deposits is to be printed using a plurality of print modules 1, the controller is programmed to operate the workpiece transport device to inwardly transport a workpiece 3 to the printing zone, and then operate the robotic arm 5 to in turn select and operate a plurality of different print modules 1 to achieve the required pattern of deposits of printing, material, with the operation of each of the print modules 1 being as described hereinabove.

In a preferred embodiment the controller is programmable “on-the-fly” so that new instructions can be inputted, for example, for a print run requiring yet another print module 1, without having to interrupt the current print run.

FIG. 2 illustrates a screen printing apparatus in accordance with a second embodiment of the present invention. This embodiment utilises a Cartesian positioning system.

The apparatus comprises a print module 101 for printing a pattern of deposits of a printing material on a workpiece 103, a positioning assembly 105 for positioning the print module 101 on the workpiece 103, and a controller for controlling the print module 101 and the positioning assembly 105.

The apparatus further comprises a workpiece transport device for transporting workpieces 103 to a printing zone in which the print module 101 is operable to print material deposits on a respective workpiece 103. In a preferred embodiment the workpiece transport device includes a pair of guide rails along which workpieces 103 are transported to the printing zone.

The print module 101 is a unitary assembly which comprises a housings 109, a printing screen 111 which is mounted to the housing 109, a print head 113 which is movably disposed relative to the housing 109 to apply printing material to the printing screen 111 and print material deposits on the workpiece 103, and a carriage assembly 115 for supporting and driving the print head 113 over the printing, screen 111.

The print head 113 comprises a squeegee print head or a pressure-driven print head as disclosed, for example, in WO-A-98/16387, the content of which is hereby incorporated by reference. In a preferred embodiment the print head 113 is a pressure-driven print head; such a print head 113 advantageously allowing for the printing of inverted workpieces 103.

The carriage assembly 115 comprises a pair of guide rails 117, 117 which are mounted to the housing 109, a support block 119 which is slideably disposed to the guide rails 117, 117 and supports the print head 113, and a drive unit 120 which includes a motor-driven continuous drive belt 121 for driving the support block 119 and hence the print head 113 over the printing screen 111. In alternative embodiments the carriage assembly 115 could be driven by a worm drive, a pulley system or any other conventional drive mechanism.

The carriage assembly 115 further comprises at least one actuator 122 for biasing the print head 113 into pressure contact with the printing screen 111 during printing.

The print module 101 further comprises an alignment system 123 for aligning the print module 101 to the workpiece 103 as required. In a preferred embodiment the alignment system 123 includes a video camera for locating fiducials or other locating indicators on the workpiece 103. One suitable system is disclosed in WO-A-95/14575 and U.S. Pat. No. 5,752,446, the contents of which are hereby incorporated by reference.

In a preferred embodiment the print module 101 is detachable, preferably automatically, from the positioning assembly 100 such that different print modules 101, for example, with differently patterned and/or sized printing screens 111, can be interchanged as required. In one embodiment the print module 101 could be interchanged for each print run, potentially comprising a single workpiece 103, to allow for the printing of different patterns and/or differently-sized workpieces 103. In another embodiment the print module 101 could be interchanged to allow for the printing of a plurality of different patterns and/or pattern sizes on a single workpiece 103. It is a particular advantage that the print module 101 can be readily interchanged, allowing for the use of print modules 101 having different screen patterns and/or screen sizes.

In this embodiment the print module 101 has a significantly smaller lateral dimension than the workpiece 103. In this way, the print module 101 can be operated to print in a recess in the surface of the workpiece 103, which recess would not be accessible when using a printing screen 111 having the same lateral dimension as the workpiece 103, and also print a plurality of different patterns on the same workpiece 103. The present invention thus enables different combinations of circuit patterns to be printed easily and rapidly on a workpiece 103 without the need for dedicated printing screens 111 for each of the particular combinations of circuit patterns. Of course, in other embodiments the print module 101 could have a lateral dimension the same size or greater than the workpiece 103.

The positioning assembly 105 is configured to provide for movement of the print module 101 in the X, Y and Z axes, which movement allows for the positioning of the print module 101 on the surface of the workpiece 103.

The positioning assembly 105 includes an arm unit 126 which comprises an arm 127 which extends in a direction substantially parallel to the Y axis, a coupling 128 which is disposed at the distal end of the arm 127 and to which the print module 101 is mounted, a first arm drive member 129, in this embodiment a motor, for providing angular rotation θ of the print module 101 relative to the arm 127 about the Z axis, a second arm drive member 130, in this embodiment a motor, for driving the arm 127 and hence translating the print module 101 in the Y axis, and a third arm drive member 131, in this embodiment a motor, for providing angular rotation ξ of the arm 127 and hence the print module 101 about the Y axis.

In this embodiment the coupling 128 of the arm unit 126 of the positioning assembly 105 is attached to the print module 101 by a mechanical connection. In this embodiment the coupling 128 includes a clamp and the print module 101 includes a structural feature, for example, a protrusion or a handle, which is engaged by the clamp on the coupling 128. In another embodiment the print module 101 includes a clamp and the coupling 128 includes a structural feature, for example, a protrusion or a handle, which is engaged by the clamp on the print module 1.

In another embodiment the coupling 128 on the arm unit 126 of the positioning assembly 105 can be attached to the print module 101 by a magnetic connection. In one variant the coupling 128 could include an electromagnet which is magnetically clamped to the print module 101. In another variant the print module 101 could include an electromagnet which is magnetically clamped to the coupling 128.

The positioning assembly 105 further includes a beam unit 132 which comprises a beam 133 which extends in a direction substantially parallel to the X axis and to which the arm 127 of the arm unit 126 is movably disposed, a first beam drive member 134, in this embodiment a motor, for driving the beam 133 and hence translating the print module 101 in the X axis, and a second beam drive member 135 for providing angular rotation φ of the beam 133 and hence the print module 101 about the X axis.

The positioning assembly 105 further includes a pillar unit 136 which comprises a pillar 137 which extends in a direction substantially parallel to the Z axis and to which the beam 133 is movably disposed, a first pillar drive member 138, in this embodiment a motor, for driving the pillar 137 and hence translating the print module 101 in the Z axis, and a second pillar drive member 139 for providing angular rotation γ of the pillar 137 about the Z axis and hence rotate the print module 101 in an arc about the Z axis.

By providing for angular rotation θ of the print module 101 about the Z axis, that is, an axis perpendicular to the plane of the printing screen 111, a pattern in the printing screen 111 can be deposited with any orient on a planar surface. By further providing for angular rotation φ, ξ about the X and Y axes, the print module 101 can be translated and rotated to any position in space and allows for the printing onto non-planar surfaces.

In this embodiment the controller is a programmable computer. The controller can be programmed to position the print module 1 at the required position or sequentially at the required positions and control the operation of the print module 1.

In one mode of operation, the controller is programmed to operate the workpiece transport device to inwardly transport a workpiece 100 to the printing zone, and then operate the positioning assembly 105 first to pick up a selected print module 101 from a store in an acquiring step, position the selected print module 101 in a predetermined position above the workpiece 103, and then, in a printing step, move the selected print module 101 into abutment with the workpiece 103 and drive the print head 113 across the printing screen 111 to deposit a pattern of deposits of printing material onto the workpiece 103. The printing step can then be repeated on further workpieces 103 until a given print run is completed. Where a plurality of workpieces 103 are to be printed in a print run, then at the same time, while a workpiece 103 is being printed, a new workpiece 103 to be printed is transported to the printing zone and a printed workpiece 103 is transported from the printing zone. The print module 101 is then returned to the store by the positioning assembly 105 under the control of the controller. In a subsequent print run, a different print module 101, for example, with a differently-patterned printing screen 111, could be picked up by the positioning assembly 105, whereupon the above steps would then be repeated to provide a print run of workpieces 103 having the different printed pattern thereon. The printing steps may be interrupted with a cleaning step in which the print module 101 is moved to a cleaning station and the printings screen 111 wiped clean, as required.

In another mode of operation, where a customised pattern of deposits is to be printed using a plurality of print modules 101, the controller is programmed to operate the workpiece transport device to inwardly transport a workpiece 103 to the printing zone, and then operate the positioning assembly 105 to in turn select and operate a plurality of different print modules 101 to achieve the required pattern of deposits of printing material, with the operation of each of the print modules 101 being as described hereinabove.

In a preferred embodiment the controller is programmable “on-the-fly” so that new instructions can be inputted, for example, for a print run requiring yet another print module 101, without having to interrupt the current print run.

Finally, it will be understood that the present invention has been described in its preferred embodiments and can be modified in many different ways without departing from the scope of the invention as defined by the appended claims.

In other embodiments various other mechanisms can be utilised to position the print module 1, 101. The only necessary movement of the print module 1, 101 is in the X, Y and Z directions, with angular rotation θ of the print module 1, 101 about the Z axis, that is, an axis perpendicular to the printing screen 11, 111 being preferable.

In another modification, whilst the above-described embodiments provide a printing module 1, 101 of unitary construction which is positioned by a robotic arm 5 or positioning assembly 105, the apparatus could include first and second robotic arms 5 or positioning assemblies 105 for separately positioning and operating the printing screen 11, 111 and the print head 13, 113.

It will also be understood that the screen printing apparatus of the present invention need not be used alone as a dedicated screen printer, but could be incorporated in other equipment. In one embodiment the screen printing apparatus could form part of another machine with a different function, for example, a component placing mechanism.

1. A print module for a screen printing apparatus, the print module comprising, as a detachable unitary assembly, a printing screen, a print head movable across the printing screen, and a drive mechanism for moving the print head with respect to the printing screen.

2. The print module of claim 1, further comprising a housing to which the printing screen, the print head and the drive mechanism are mounted.

3. The print module of claim 1 or 2, wherein the drive mechanism comprises a continuous belt connected to the print head and a motor for driving the belt to move the print head across the printing screen.

4. The print module of any of claims 1 to 3, wherein the drive mechanism comprises at least one actuator which is operable to drive the print head into pressure contact with the printing screen.

5. The print module of any of claims 1 to 4, further comprising a locator for locating the print module on the workpiece.

6. The print module of claim 5, wherein the locator comprises a video camera which is movable with the print module to detect markers on the workpiece.

7. A screen printing apparatus for printing a predeterminable pattern of deposits of printing material onto a workpiece, the screen printing apparatus comprising:
at least one print module of any of claims 1 to 6; and
a positioning unit for positioning a print module with respect to the workpiece.

8. The apparatus of claim 7, wherein the print module is detachably mounted to the positioning unit.

9. The apparatus of claim 8, comprising a plurality of print modules, with the printing screens of each being different.

10. The apparatus of any of claims 7 to 9, wherein the positioning unit is configured to move the print module in a plane along substantially orthogonal X and Y axes, and vertically towards and away from the workpiece along a Z axis substantially orthogonal to the X and Y axes.

11. The apparatus of claim 10, wherein the positioning unit is configured to rotate the print module about a point in the plane defined by the X and Y axes.

12. The apparatus of claim 11, wherein the positioning unit is configured to rotate the print module about the Z axis.

13. The apparatus of any of clams 10 to 12, wherein the positioning unit is configured to rotate the print module about the X axis.

14. The apparatus of any of claims 10 to 13, wherein the positioning unit is configured to rotate the print module about the Y axis.

15. The apparatus of any of claims 10 to 14, wherein the positioning unit is a robotic positioning arm.

16. The apparatus of any of claims 10 to 14, wherein the positioning unit is a positioning assembly comprising an arm extending substantially parallel to the Y axis and to which the print module is mounted, a beam extending substantially parallel to the X axis, a pillar extending substantially parallel to the Z axis, and drive members for providing relative movement of the arm, the beam and the pillar.

17. The apparatus of claim 16, wherein the positioning assembly further comprises a drive member for rotating the print module about the Z axis.

18. The apparatus of claim 16 or 17, wherein the positioning assembly further comprises drive members for rotating the arm about the Y axis and the beam about the X axis.

19. The apparatus of any of claims 16 to 18, wherein the positioning assembly ether comprises a drive member for rotating the pillar about the Z axis.

20. The apparatus of any of claims 7 to 19, wherein the printing screen has a smaller lateral dimension than that of the workpiece.

21. A method of screen printing a predeterminable pattern of deposits of printing material onto a workpiece, the method comprising the steps of:
picking up a print module of any of claims 1 to 6 in an acquiring step;
moving the selected print module to a predeterminable position above a workpiece in a printing zone; and
moving the print module into abutment with the workpiece and operating the print module to print deposits of printing material onto the workpiece in a printing step.

22. The method of claim 21, further comprising the steps of:
moving the print module out of abutment with the workpiece;
transporting a printed workpiece from the printing zone; and
transporting another workpiece to the printing zone.

23. The method of claim 22, further comprising the step of:
moving the print module into abutment with the other workpiece and operating the print module to print deposits of printing material onto the other workpiece in a printing step.

24. The method of any of claims 21 to 23, further comprising the steps of:
moving the print module to a cleaning station; and
cleaning the print head.

25. A method of printing a predeterminable pattern of deposits of printing material onto a workpiece, the method comprising the steps of:
selecting a first print module;
printing deposits of printing material onto a workpiece using the first-selected print module;
returning the first-selected print module;
selecting a second print module; and
printing deposits of printing material onto the workpiece using the second-selected print module.

26. The method of claim 25, further comprising the steps of:
selecting a further print module; and
printing deposits of material onto the workpiece using the further-selected print module.

27. The method of claim 25 or 26, wherein the print module comprises, as a unitary assembly, a printing screen, a print head movable across the printing screen, and a drive mechanism for moving the print head with respect to the printing screen.
